(19) United States
(12) Patent Application Publication
(10) Pub. No.: US 2007/0133849 A1
(43) Pub. Date: Jun. 14, 2007

(54) Method and apparatus for visualisation of a tubular structure

(75) Inventors: Stewart Young, Hamburg (DE); Thomas Netsch, Hamburg (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., EINDHOVEN (NL)

(21) Appl. No.: 10/595,694

(22) PCT Filed: Nov. 2, 2004
(86) PCT No.: PCT/IB04/52266

§ 371 Date: May 5, 2006

(30) Foreign Application Priority Data
Nov. 14, 2003 (EP) 03104211.2

(51) Int. Cl. G06K 9/00

(52) U.S. Cl. 382/128

(57) ABSTRACT

The present invention relates to a method and a corresponding apparatus for visualization of a tubular structure of an object by use of a 3D image data set of said object. In order to provide a more efficient and illustrative visualization a method is proposed comprising the steps of: —generating and visualising a curved planar reformation view (C) from a symbolic pathway view (B) of said tubular structure, said symbolic pathway view (B) representing said tubular structure and the pathway points of said symbolic pathway being assigned with their 3D spatial position data, and —generating and visualising at least one planar view (O) of said object (1) through a viewing point (V) of said tubular structure selected in said curved planar reformation view (C) or said symbolic pathway view (B).

The present invention relates to a method of visualisation of a tubular structure of an object by use of a 3D image data set of said object. Further, the present invention relates to a corresponding apparatus for visualisation, to an apparatus for acquiring and processing medical image data and to a computer program for implementing said method on a computer.

WO 03/021532 A2 (ID 201230) discloses a method and an apparatus for segmentation of an object in a 2D or 3D image data set by extracting a path along the object. In order to obtain this path with high accuracy and reliability the method comprises the steps of selecting a start point of the path as first active point, adapting an adaptable model to the object in a first active section around the start point, finding the next point of the selected region by use of said adaptable model, wherein the last step is repeated until an end point of the path or a predetermined number of iterations is reached. It is thus possible, via the use of an appropriate geometric model, to discriminate between very closely separated structures, so that only anatomically connected pathways are selected. As a result a symbolic pathway view of a selected tubular structure can be generated and visualized, such as a symbolic pathway view of a vessel structure in a 3D medial image data set of a patient. Further, maximum intensity projections can be generated and visualized in which overlapping/occluding vessels are suppressed.

However, often such a symbolic pathway view and/or a maximum intensity projection does not give a sufficiently clear and illustrative visualisation of the object under investigation or the location and path of the tubular structure within the object, and it is desired to review the original 3D data in closer detail. Furthermore, maximum intensity projection is not always appropriate, for example if there are other brighter structures that occlude pathways of interest. It is thus an object of the present invention to provide a method and a corresponding apparatus for visualization of a tubular structure of an object which allow the generation of more illustrative and clear views, and which allow straightforward navigation of viewing positions to and along the underlying 3D data on the pathway of interest.

This object is achieved according to the present invention by a method as claimed in claim 1 comprising the steps of: —generating and visualising a curved planar reformation view from a symbolic pathway view of said tubular structure, said symbolic pathway view representing said tubular structure and the pathway points of said symbolic pathway being assigned with their 3D spatial position data, and —generating and visualising at least one planar view of said object through a viewing point of said tubular structure selected in said curved planar reformation view or said symbolic pathway view.

A corresponding apparatus is defined in claim 8 comprising: —means for storing said 3D image data, —means for generating a curved planar reformation view. from a symbolic pathway view of said tubular structure, said symbolic pathway view representing said tubular structure and the pathway points of said symbolic pathway being assigned with their 3D spatial position data, —means for storing said 3D spatial; position data of said symbolic pathway, —means for generating at least one planar view of said object through a viewing point of said tubular structure selected in said curved planar reformation view or said symbolic pathway view, —means for visualising said symbolic pathway, said curved planar reformation view and said at least one planar view, and —means for selecting a viewing point in said curved planar reformation view or said symbolic pathway view.

The invention is based on the idea to link a symbolic pathway representation to the underlying 3D image data, which is realized by a two-step interaction. In a first step a symbolic pathway view is linked to a curved planar reformation (CPR) view. This is, for instance, implemented by selection of a path in said symbolic pathway view in a 3D viewer where all available paths are displayed symbolically as 3D curves. This activates a link to display a CPR-view based on the pathway through the original 3D image data. In a second step the CPR-view is linked to at least one planar view, for instance to a standard orthoviewer of three orthogonal views in the 3D volume. This is, for instance, implemented in that the reformatting maps distance along the path to the vertical image coordinate of the CPR-view. A selection within the CPR-view (or the symbolic pathway view) indicates a (known) viewing point, which is a 3D path point, through which the at least one planar view is shifted. In case of visualizing three orthogonal views the intersection of the orthoviews is shifted to said viewing point.

This linkage proposed according to the present invention allows the user to very rapidly review the original 3D image data along a path of interest. In an implementation this rapid review is possible simply by dragging a pointer within the CPR-view (or the symbolic pathway view), causing the at least one planar view or the orthoviewer to “slide” along the selected path. The linkage to the CPR-view provides target overview of the 3D image data along the length of a selected tubular structure. Further, linkage to the at least one planar view or the preferably provided orthoviews allows closer inspection of areas of interest and eases quantitative measurement since the, CPR-view introduces spatial distortions when estimating distances or areas. It is noted that 3D pathways of interest are rarely confined to a single flat plane, rather they are typically tortuous and move out of any particular chosen view plane. Therefore real time interaction is important to facilitate review of such pathways. In addition, a 3D view may be provided giving a simplified symbolic view of the possibly complex extracted network of tubular structures.

The visualisation of tubular structures, such as a patient's blood vessels, by use of curved planar reformation is known from “CPR-Curved Planar Reformation”, Armin Kanitsar et al., Proc. IEEE visualization 2002, October 2002, pp. 37-44. Therein different methods are presented to generate CPR images by which longitudinal cross sections can be generated for diagnostic purposes in order to show the lumen, wall and surrounding tissue of a tubular structure in a curved plane. However, such CPR-views are typically highly distorted and may thus show, in the application for showing a vessel, a stenosis where no stenosis is actually present, or indicate no stenosis where a stenosis is actually present. Thus, only using a CPR-view is not generally suitable for diagnostic purposes. This problem is avoided by the method according to the present invention allowing the user to get a clearer picture of the location and path of a selected tubular structure within the object.

Preferred embodiments of the invention are defined in the dependent claims. Preferably, said at least one planar view is generated by use of the 3D spatial position data assigned to the selected viewing point. That is, the 3D spatial position data assigned to the pathway points of the symbolic pathway view are evaluated after selection of the viewing point. This is possible since the viewing point, no matter whether it is selected in the symbolic pathway view or in the CPR-view, allows identification of a single pathway point to which this viewing point relates, and thus allows selection of the corresponding 3D spatial position data assigned to said pathway point. In case of generating and visualizing three orthogonal views, as proposed according to a further embodiment, the viewing point and the corresponding 3D spatial position data indicate the point at which the three orthogonal views intersect.

Generally, the symbolic pathway view may be obtained by any method. However, according to a preferred embodiment the symbolic pathway view is obtained by segmentation of the desired tubular structure in said 3D image data set, as for instance described in WO 03/021532 A2. In a further preferred embodiment the step of generating and visualising the CPR-view includes a step of selecting a viewing direction and a viewing-up direction determining the viewing angle of said CPR-view. The user thus has the freedom to select, for CPR viewing, from which perspective he wants to see the tubular structure within the object. Depending on the selected perspective the amount of distortion present in the CPR can vary, although in all perspective views the selected tubular structure will be completely shown.

It may be further provided in an embodiment that the selection of the viewing point can be interactively changed, wherein after selection of a new viewing point the at least one planar view through the new viewing point is, nearly in real-time, generated and visualized. For instance, the user may slide through the CPR-view or the symbolic pathway view using a pointer or the computer mouse, thus changing the viewing point which immediately has an effect on the visualized at least one planar view which changes almost in real-time so that the user may immediately see the planar view through the original 3D image data corresponding to the current viewing point, i.e. the current position of the pointer or computer mouse. An effective and illustrative visualisation of the selected tubular structure is thus provided.

Preferably, the invention is applied in medical imaging, and a tubular structure will thus be a vessel, bone, airway, colon or spine of a patient. The 3D image data set may be any medical image data set, in particular, a 3D rotational angiography, CT angiography or MR data set.

The invention relates also to an apparatus for acquiring and processing medical image data, in particular a magnetic resonance apparatus, computer tomography apparatus, X-ray apparatus or ultrasound apparatus, comprising means for acquiring medical image data and means for processing said image data including an apparatus for visualization as proposed according to the present invention and as described above. Further, the invention relates to a computer program comprising computer program means for causing a computer to perform the steps of the method as described above when said computer program is run on a computer.

The invention will now be explained in more detail with reference to the drawings in which:

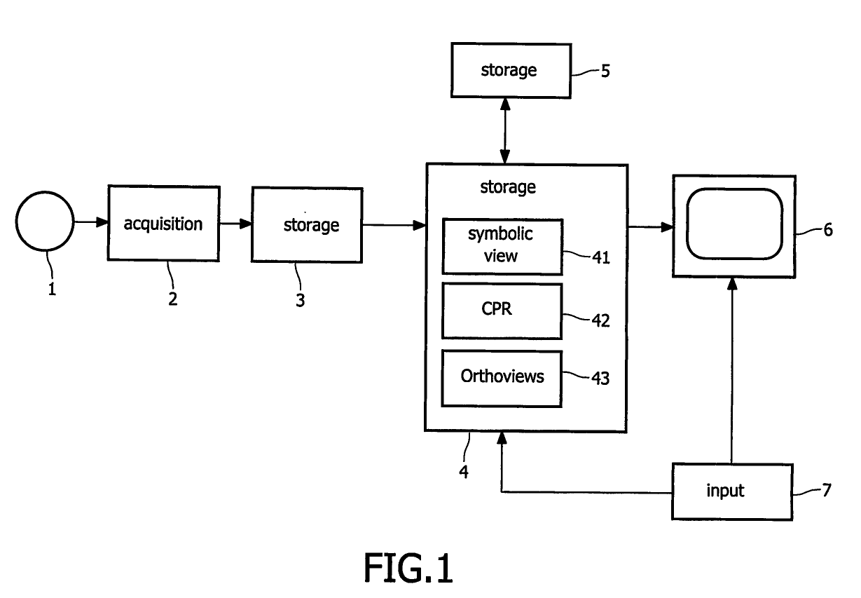

FIG. 1 shows a block diagram of an apparatus according to the present 20 invention,

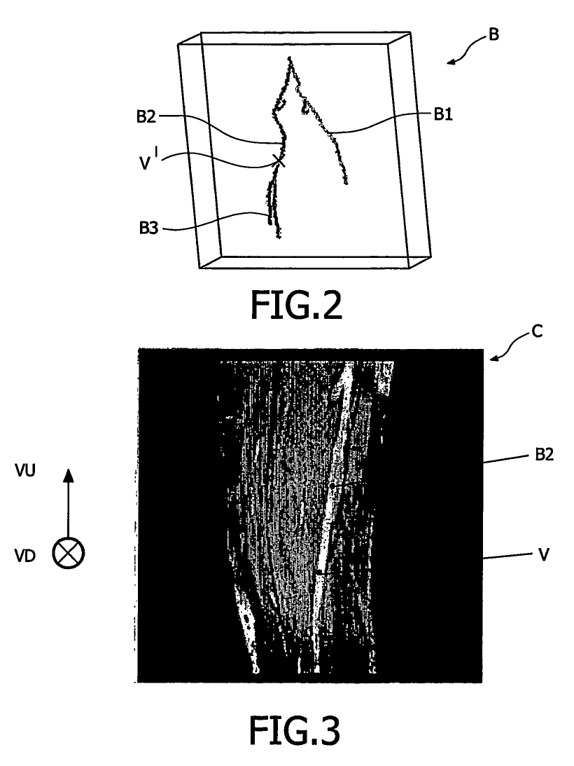

FIG. 2 shows a symbolic pathway view,

FIG. 3 shows a CPR-view and

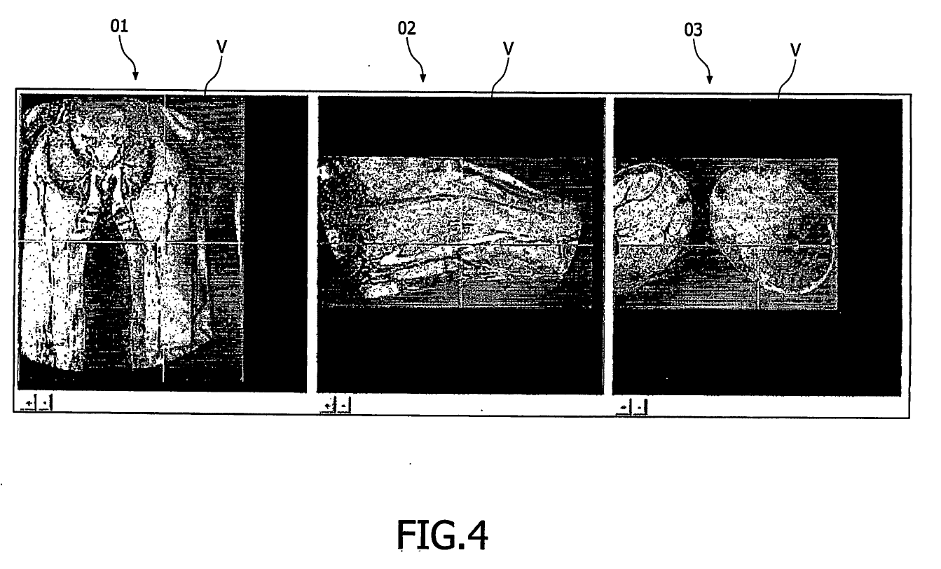

FIG. 4 shows three orthogonal views of an object of interest.

FIG. 1 schematically shows a block diagram of an apparatus for visualization according to the present invention. By use of a data acquisition unit 2 3D image data of a region of interest of an object 1, for instance of a patient's leg, are acquired. The acquired 3D image data are stored in a memory 3, such as a harddisk of a 30 computer, and are processed by a processing unit 4, such as a CPU of a computer which has been programmed in an appropriate way. The processing unit 4 comprises different units for generating and visualizing different views which are linked according to the present invention so that a user can see the tubular structure of interest from different perspectives and/or in different viewing modes. In particular, the processing unit 4 comprises a first unit 41 for generating a symbolic pathway view of the tubular structure, a second unit 42 for generating and visualizing a curved planar reformation view showing the tubular structure and a third unit 43 for generating at least one planar view, preferably three orthogonal views. For storage of particular data used during processing a separate memory 5 is provided. The different views can be displayed on a display screen 6, which preferably has separate windows for simultaneously showing the different views. Finally, an input unit 7 is provided for user input and selection of a view perspective or other parameters of that kind.

In the following one possible way of operation shall be explained by way of example. In this example it shall be assumed that a medial 3D image data set of a patient's leg has been acquired and that the vessel pathways within one leg shall be examined. Therefore, in a first step and by use of the first processing unit 41, a symbolic pathway view of the vessel pathways in the leg are generated. Different methods are known for extracting the vessel pathway; an automatic extraction method is described in WO 03/021532 A2 to which reference is herewith made. As a result a symbolic pathway view B as shown in FIG. 2 is obtained where the different branches B1, B2, B3 of the vessel pathways in a portion of the leg for which the 3D image data set has been obtained are schematically shown. This symbolic pathway view B can then be displayed on the display 6, for instance in a separate window.

As a next step and by use of the second processing unit 42, a CPR-view is generated, particularly by generation of longitudinal cross-sections in a curved plane for a selected vessel branch, i.e. by use of the input unit 7 the user can select one of the branches B1, B2, B3 shown in the symbolic pathway view B, for which a CPR-view C shall be generated and visualized. In the example shown in FIG. 2 the user has selected vessel branch B2 for which a CPR-view C has been generated as shown in FIG. 3. As can be seen therein the whole length of the vessel branch B2 is shown in the CPR-view C although the vessel does not lie completely in one single plane, i.e. the CPR-view C generally is a distorted view showing image data along a curved plane through the object of interest. Different methods of generating a CPR-view are known and shall not be discussed any further here. Reference is particularly made to the above mentioned article of Armin Kanitsar et al. “CPR—Curved Planar Reformation”. For use according to the present invention it is not relevant which particular method of generating a CPR-view will be applied.

It shall be noted, that generally in a CPR view the viewing direction VD and the view-up direction VU of the CPR-view C can be pre-selected by the user or are given as default parameters.

By use of this CPR-view C and/or the symbolic pathway view B the user can select a pathway point along the selected branch B2 of the vessel pathway for which at least one planar view shall be generated and displayed. This selected pathway point shall be called viewing point V which has been, in the shown example, selected in the CPR-view C. The 3D spatial position data of the selected viewing point V can be easily obtained, since the 3D position data is available for all path points, and a CPR point maps directly to a point on the paths length. Preferably, for each pathway point of the vessel pathways in the symbolic pathway view B the 3D spatial position data are known and stored in the storage 5, so that after selection of the viewing point V in the CPR-view C a link can be made to the corresponding pathway point V′ in the symbolic pathway view B′ from which the assigned 3D spatial position data can be retrieved from the storage 5.

In a third step by use of the third processing unit 43 the at least one planar view through the viewing point V is then generated from the original 3D image data stored in the memory 3. Preferably, three orthogonal views O1, O2, O3 are generated by a known orthoviewer where the viewing point V determines the point of intersection of the three orthogonal planes. The CPR-view C and the one or more planar views O1, O2, O3 are then displayed simultaneously with the symbolic pathway view B in separate windows on the display 6. Three orthogonal views O1, O2, O3 which intersect in the viewing point V are shown in FIG. 4.

By use of the input unit 7 the user has the possibility to interactively change the position of the viewing point V, for instance by moving a pointer upwards and downwards in the CPR-view C shown in FIG. 3. Upon each change of the viewing point V the at least one planar view will be automatically and almost in real-time updated so that the user can get a complete overview of the path and the surrounding tissue of the tubular structure using the information from the symbolic pathway view, the CPR-view and the at least one planar view at the same time. The present invention allows a rapid, tubular structure-targeted viewing for any kind of 3D image data, reducing the degree of tedious interaction needed to track pathways slicewise, in cases when a maximum intensity projection (MIP) view is compromised (for instance in novel magnetic resonance angiography approaches like balanced-FFE). Image data for a tubular structure can be brought into focus via the 3D symbolic pathway viewer linked to the CPR-viewer, and raw data on the path can be reviewed using the CPR-orthoviewer link. The importance of effective navigation methods, in particular for vessel navigation, is increasing with the emergence of new MR angiography approaches, such as balanced FFE/TFE techniques and bloodpool contrast agents. Thus, the invention is preferably applied in medical imaging using, for instance, CT angiography data, 3D rotational angiography data or MR data. However, the invention may also be applied in other technical fields, such as for instance material inspection for the detection of capillary cracks in a solid element.

The present invention provides a method allowing a user to get a better overview of complex pathways in 3D data by providing a more effective visualization. The invention provides a close integration of a symbolic view and the underlying 3D image data. A targeted-path overview (CPR) is used to link to the data rather than a local path-actual view, and a preferably used 3D symbolic viewer allows more intuitive navigation of tree-structures.

1. Method of visualisation of a tubular structure of an object by use of a 3D image data set of said object, comprising the steps of: —generating and visualising a curved planar reformation view from a symbolic pathway view of said tubular structure, said symbolic pathway view representing said tubular structure and the pathway points of said symbolic pathway being assigned with their 3D spatial position data, and—generating and visualising at least one planar view of said object through a viewing point of said tubular structure selected in said curved planar reformation view or said symbolic pathway view.

2. Method as claimed in claim 1, wherein said at least one planar view is generated by use of the 3D spatial position data assigned to the selected viewing point.

3. Method as claimed in claim 1, wherein three orthogonal views are generated and visualised which intersect in the selected viewing pointy.

4. Method as claimed in claim 1, wherein said symbolic pathway view of said tubular structure is obtained following segmentation of said tubular structure in said 3D image data set.

5. Method as claimed in claim 1, wherein said step of generating and visualising said curved planar reformation view includes a step of selecting a viewing direction and a viewing up direction determining the viewing angle of said curved planar reformation view.

6. Method as claimed in claim 1, wherein the selection of said a viewing point can be interactively changed, wherein after selection of a new viewing point said at least one planar view through said new viewing point is newly generated and visualised.

7. Method as claimed in claim 1, wherein said tubular structure is a vessel, bone, airway, colon or spine of a patient and wherein said 3D image data set is a medical image data set, in particular a 3D rotational angiography, CT angiography or MR data set.

8. Apparatus for visualisation of a tubular structure of an object by use of a 3D image data set of said object, comprising: —means for storing said 3D image data,—means for generating a curved planar reformation view from a symbolic pathway view of said tubular structure, said symbolic pathway view representing said tubular structure and the pathway points of said symbolic pathway being assigned with their 3D spatial position data,—means for storing said 3D spatial position data of said symbolic pathway,—means for generating at least one planar view of said object through a viewing point of said tubular structure selected in said curved planar reformation view or said symbolic pathway view,—means for visualising said symbolic pathway view, said curved planar reformation view and said at least one planar view, and means (for selecting a viewing point in said curved planar reformation view or said symbolic pathway view.

9. Apparatus for acquiring and processing medical image data, in particular magnetic resonance apparatus, computer tomography apparatus, x-ray apparatus or ultrasound apparatus, comprising means for acquiring medical image data and means for processing said image data including an apparatus for visualisation according to claim 8.

10. Computer program comprising computer program means for causing a computer to perform the steps of the method as claimed in claim 1 when said computer program product is run on a computer.
